(19) United States
(12) Patent Application Publication
(10) Pub. No.: US 2016/0371593 A1
(43) Pub. Date: Dec. 22, 2016

(54) LIVING ACTIVITY INFERENCE DEVICE, AND PROGRAM

(71) Applicant: PANASONIC INTELLECTUAL PROPERTY MANAGEMENT CO., LTD, Osaka-shi, Osaka (JP)

(72) Inventors: Takashi NISHIYAMA, Hyogo (JP); Noriyoshi SHIMIZU, Osaka (JP); Tomohiko FUJITA, Kyoto (JP); Tomoharu NAKAHARA, Hyogo (JP)

(21) Appl. No.: 15/122,327

(22) PCT Filed: Feb. 12, 2015
(86) PCT No.: PCT/JP2015/000646

§ 371 Date: Aug. 29, 2016

(30) Foreign Application Priority Data
Mar. 11, 2014 (JP) 2014-048001

(51) Int. Cl. G06N 5/04; G06N 7/00; G06Q 30/02

(52) U.S. Cl. CPC G06N 5/046; G06Q 30/0201; G06N 7/005

(57) ABSTRACT

An inferrer calculates, for each kind of living activities, an occurrence probability defining a probability that a corresponding living activity occurs, based on an operational state of an electric appliance determined by a detector for each of sections at an inference target time by use of prior probabilities, first conditional probabilities, and second conditional probabilities, and infers that a living activity having a highest occurrence probability has occurred at inference target time. Prior probabilities each define a probability at which a corresponding living activity occurs in one day. First conditional probabilities each define active and inactive probabilities of electric appliance belonging to a corresponding section under a condition where a corresponding living activity occurs. Second conditional probabilities each define probabilities of occurrence of a corresponding living activity within respective time periods divided from one day under a condition where a corresponding living activity occurs.

### TECHNICAL FIELD

The present invention relates to living activity inference devices and programs, and more particularly, to a living activity inference device for inferring a living activity based on a resource consumption status in a residence and a program therefor.

### BACKGROUND ART

In the past, there has been proposed a living activity inference device for inference of a living activity of a resident based on an operational state of an electric appliance used in a residence (see Document 1 [WO 2013/157175 A1]). In this living activity inference device, a group of rules are stored. Each rule provides a conclusion indicative of an activity class defined by classification of the living activity, in response to a given condition including an appliance class assigned to the electric appliance for classifying a type of the electric appliance and an operational state of the electric appliance. When receiving operational states (an event such as a start of working and an end of working) of electric appliances, the activity inference device applies, to the group of rules, the received operational states and the appliance classes of the electric appliances to extract the activity class as a result.

The group of rules used by the living activity inference device disclosed in Document 1 is fixed. Hence, an actual living activity may not correctly conform to that derived from the group of rules.

### SUMMARY OF INVENTION

An objective of the present invention is to propose a living activity inference device having an improved inference accuracy of the living activity compared to a conventional configuration, and a program for realizing the living activity inference device by a computer.

A living activity inference device according to an aspect of the present invention includes an obtainer, an appliance operation detector, a storage device, an activity inferrer, and an outputter. The obtainer is configured to obtain, for each of sections of a residence, data on a resource consumption status of one or more appliances belonging to a corresponding one of the sections. The appliance operation detector is configured to determine, for each of the sections, an operational state indicative of whether the one or more appliances belonging to a corresponding one of the sections are active or inactive, from the data on the resource consumption status obtained by the obtainer for each of the sections. The storage device is configured to preliminarily store prior probabilities, first conditional probabilities, and second conditional probabilities. The prior probabilities each define a probability at which a corresponding one of pre-defined multiple kinds of living activities occurs in one day. The first conditional probabilities each define active and inactive probabilities of the one or more appliances belonging to a corresponding one of the sections under a condition where a corresponding one of the multiple kinds of living activities occurs. The second conditional probabilities each define probabilities of occurrence of a corresponding one of the multiple kinds of living activities within respective time periods divided from one day under a condition where the corresponding one of the multiple kinds of living activities occurs. The activity inferrer is configured to calculate, for each of the multiple kinds of living activities, an occurrence probability defining a probability that a corresponding one of the multiple kinds of living activities occurs at an inference target time, according to Bayes' theorem based on the operational state of the one or more appliances determined by the appliance operation detector for each of the sections at the inference target time by use of the prior probabilities, the first conditional probabilities, and the second conditional probabilities. The activity inferrer is further configured to infer that a living activity having a highest occurrence probability of the multiple kinds of living activities has occurred at the inference target time.

A program according to an aspect of the present invention is a program, when executed by a computer, causing the computer to function as the living activity inference device described above.

A recoding medium on which the program is recorded may be a computer readable recoding medium.

### BRIEF DESCRIPTION OF DRAWINGS

FIG. 1 is a block diagram according to an embodiment.

FIG. 2 is a graph showing conditional probabilities stored in a storage device according to the embodiment.

FIG. 3 is another graph showing conditional probabilities stored in the storage device according to the embodiment.

FIG. 4 is another graph showing conditional probabilities stored in the storage device according to the embodiment.

FIG. 5 is a graph showing prior probabilities stored in the storage device according to the embodiment.

FIG. 6 is a diagram showing transition probabilities stored in the storage device according to the embodiment.

FIG. 7 is a graph showing time variations of amounts of power consumed by electric appliances according to the embodiment.

FIG. 8 is a diagram of a graphical model illustrating a stochastic reasoning according to the embodiment.

FIG. 9 is a diagram of a graphical model illustrating a stochastic reasoning using a transition probability according to the embodiment.

FIG. 10 is a graph showing a history of inferred coming-home time according to the embodiment.

FIG. 11 is a graph showing a frequency distribution of inferred coming-home time according to the embodiment.

### DESCRIPTION OF EMBODIMENTS

A living activity inference device according to the present embodiment is configured to infer a living activity of a resident (user) based on a resource consumption status, with regard to each of sections in a residence, of one or more appliances situated in a corresponding section. The sections indicate spatial regions in the residence, and are classified according to their intended purposes in the residence. The section may conceptually indicate a particular location such as a room of the residence, and/or an intended purpose of a particular location. The resource consumed in the residence may include energy resources such as electricity and gas, and water.

The present embodiment is explained according to a case where the appliance consuming the resource is an electric appliance. In other words, the living activity inference device described hereinafter is configured to determine operational states of the electric appliances based on consumption statuses of power consumed by the electric appliances belonging to the sections, and to infer the living activity of the resident based on the determined operational states of the electric appliances.

The living activity inference device is configured to infer which one of pre-defined multiple living activities corresponds to a living activity that has been actually performed by the resident at an inference target time. In the embodiment, three distinguished states, an at-home state, a go-out state, and a sleep state, are defined as the multiple living activities, and a living activity at the inference target time is inferred from them. The at-home state indicates a state where the resident is at home but is not asleep.

The living activity inference device may be configured to detect change in the living activity as an event performed by the resident. The living activity inference device is configured to: detect change in the living activity from the at-home state to the sleep state, as a go-to-bed event; detect change in the living activity from the sleep state to the at-home state, as a wake-up event; detect change in the living activity from the at-home state to the go-out state as a going-out event; and detect change in the living activity from the go-out state to the at-home state as a coming-home event.

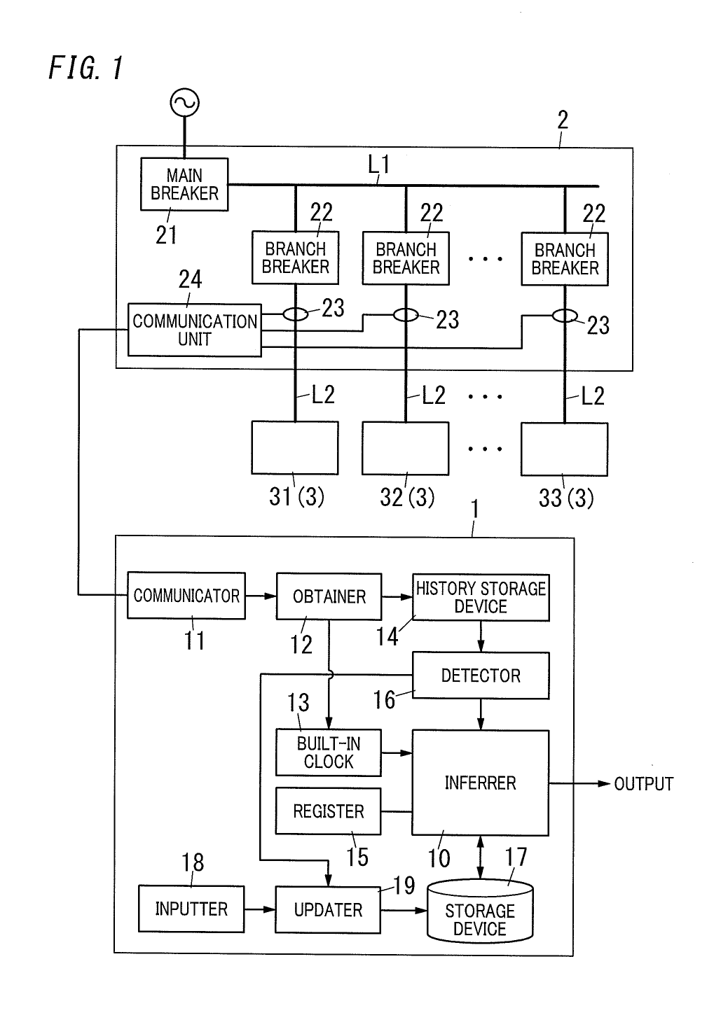

As shown in FIG. 1, one main breaker 21 and multiple branch breakers 22 are housed in a distribution board 2 that is installed in the residence. A trunk line L1 extends from the main breaker 21, and is branched to branch lines L2 by the branch breakers 22, respectively, to deliver electric power to electric appliances 3 connected to the branch lines L2. In the example of FIG. 1, each branch line L2 is connected with only one electric appliance 3, but two or more electric appliances 3 may be connected to one branch line L2. The branch line L2 may be connected with an outlet (receptacle) for receiving a plug of the electric appliance 3.

In the present embodiment, each room (for example, living room, kitchen, bed room, and the like) of the residence corresponds to one section. Each branch line L2 is connected with one or more electric appliances 3 that exist in a same section. Also, two or more branch lines L2 may be associated with one section. Hereinafter, one or more electric appliances 3 connected to the branch line(s) L2 associated with the living room are referred to as an electric appliance 31, one or more electric appliances 3 connected to the branch line(s) L2 associated with the kitchen are referred to as an electric appliance 32, and one or more electric appliances 3 connected to the branch line(s) L2 associated with the bed room are referred to as an electric appliance 33.

The living activity inference device of the present embodiment is configured to obtain, for each of the branch lines L2, data on consumed power. Hereinafter, the data on power obtained for each of the branch lines L2 is referred to as “power data”. As shown in FIG. 1, power sensors 23 are provided on load sides of the branch breakers 22, respectively so as to individually measure the power sent through the branch lines L2. Each power sensor 23 is configured to detect a current flowing through a corresponding branch line L2 and a voltage between lines of the corresponding branch line L2. For example, a Rogowski coil is used for detecting a current. An output signal from each of the power sensors 23 is supplied to a communication unit 24, and then supplied from the communication unit 24 to the living activity inference device 1.

A place to obtain the power data of one or more electric appliances 3 may be appropriately selected from various places, if necessary. Such a place may be selected from: the trunk line L1; an electric circuit branched from the branch line L2; an outlet connected to the branch line L2; and an individual electric appliance connected to the branch line L2. Foe example, the power sensors may be provided to the outlets of the branch lines L2, respectively, and the communication unit 24 may collect respective power data measured by the power sensors of the outlets and output the power data to the living activity inference device 1. Alternatively, when the electric appliance 3 may include a communication function, the power sensor may be provided to the electric appliance 3, and the communication unit 24 may collect the power data measured by the power sensor of the electric appliance 3 and output the power data to the living activity inference device 1.

The living activity inference device 1 includes a main hardware component including a device that execute a program to realize functions described later. A specific example of the device is a microcomputer including a processor and a memory. Therefore, the living activity inference device 1 may be realized by a dedicated device, or can be realized by another device such as a general purpose computer, a tablet terminal, and a smartphone when executing a program for implementing functions described later. The program may be supplied through a telecommunication network such as the Internet and mobile network, or through a computer readable recording medium. The recording medium may be an optical disk, a hard disk, a non-volatile semiconductor memory, or the like.

As shown in FIG. 1, the living activity inference device 1 includes an inferrer 10 (activity inferrer), an obtainer 12, a detector 16 (appliance operation detector), and a storage device 17. The living activity inference device 1 of the present embodiment further includes an inputter 18 and an updater 19. The living activity inference device 1 of the present embodiment includes, in addition to the above components, a communicator 11 (communication interface), a built-in clock 13, a history storage device 14, and a register 15.

The communicator 11 is configured to communicate with the communication unit 24 in the distribution board 2. The communicator 11 receives, from the communication unit 24, the power data of the respective branch lines L2 that has measured every predetermined measurement time (e.g., one second, one minute, or the like), and outputs the received power data to the obtainer 12.

The obtainer 12 is configured to calculate the amount of energy per unit time, from the power data supplied every measurement time from the communicator 11. The unit time is an integer multiplier of the measurement time and may fall within a range of 30 seconds to 10 minutes, for example. The power sensor 23 may be configured to measure the amount of power every time segment, which is defined by equally dividing the measurement time, and the communication unit 24 may be configured to transmit, to the living activity inference device 1, an average, per the measurement time, of the amounts of power measured every time segments. In this case, the obtainer 12 can calculate the amount of energy by multiplying the measuring time by the average of the amounts of power supplied from the communication unit 24. The communication unit 24 may be configured to transmit, to the living activity inference device 1, the amount of energy per the time segment calculated from the amounts of power measured by the power sensors 23.

The built-in clock 13 is configured to indicate current date and time. The built-in clock 13 may be realized by a real-time clock.

The history storage device 14 is configured to record the amount of energy for each branch line L2 calculated by the obtainer 12 in association with a time stamp corresponding to the current date and time indicated by the built-in clock 13. In other words, the history storage device 14 stores time series data of the amount of energy for each branch line L2. A storage capacity of the history storage device 14 is selected such that the history storage device 14 can store the time series data of the amount of energy for at least some days, and is preferably selected such that the history storage device 14 can store the time series data of the amount of energy for one year or more.

The register 15 is configured to register pieces of information for individually distinguishing the electric appliances 3 in the residence in association with pieces of information for distinguishing individual groups of the branch lines L2. The register 15 associates the electric appliances 3 with the branch lines L2, and also associates the pieces of information for individually distinguishing the electric appliances 3 with pieces of information for individually distinguishing the sections of the residence, and stores them in the inferrer 10. Hereinafter, the information for individually distinguishing the sections of the residence is referred to as section information. The section information is preliminarily set when the living activity inference device 1 is installed, for example. A piece of the section information of electric appliance 3 connected to a branch line L2 is a piece of information indicating the intended purpose and the location where the electric appliance 3 is to be used, and is transmitted from the communication unit 24 of the distribution board 2 to the communicator 11, for example. The register 15 registers each piece of the section information of electric appliance 3 connected to the branch line L2 on the inferrer 10 based on the section information received by the communicator 11.

In the present embodiment, each of the branch lines L2 is registered on the inferrer 10 in association with a piece of the section information of electric appliance 3 connected to this branch line L2. For example, section names such as “living room”, “kitchen”, “bath room”, “bed room”, and the like are registered on the inferrer 10, as the pieces of the section information of electric appliance 3. With regard to a room that may be used for various purposes, such as a child room which may be used as a living room during day time and a bed room during night time, the piece of section information of electric appliance 3 connected to the branch line L2 may be changed depending on time periods of a day.

The register 15 does not necessarily register the section information with regard to all the electric appliances 3. It is sufficient that the register 15 register the section information with regard to electric appliances 3 that are connected to two or more branch lines L2 of interest which are necessary for inferring the living activity. It is also sufficient that the obtainer 12 obtains data on resource consumption status, namely the power data in the present embodiment, of the two or more branch lines L2 of interest. It should be noted that power data of the branch lines L2 that are connected to electric appliances 3 that operate according to a preliminarily determined schedule are not used for inferring the living activity, because change in the power consumed by such electric appliances 3 are not always relevant to the living activity of the resident.

The detector 16 is configured to receive, from the history storage device 14, the amount of energy for each of the branch lines L2. The detector 16 is configured to determine the operational state of the one or more electric appliances 3 connected to the branch line L2 (whether they are active or inactive) based on a change in the amount of energy obtained by the obtainer 12. Some electric appliances 3 consume standby energy even when they are inactive. However, in the present embodiment, a state of the electric appliance 3 consuming the standby energy is regarded as inactive.

The detector 16 is configured to, for each of the branch line L2, compare the amount of energy of this branch line L2 with a predetermined threshold to determine whether the one or more electric appliances connected to this branch line L2 are active or inactive. In this regard, the detector 16 preliminarily sets thresholds used for determining the operational states, based on the amounts of energy that are respectively associated with the branch lines L2 and stored in the history storage device 14. Specifically, the detector 16 sets the threshold used for determining the operational state, for each of the branch lines L2, to a minimum value of values that satisfy a condition where the amount of energy of the branch line L2 of interest is kept equal to or less than the value for a predetermined holding time period or more. Hence, the threshold determined by the detector 16 for each of the branch lines L2 in this manner indicates a peak value of the standby energy for this branch line L2.

The storage device 17 stores prior probabilities each defining a probability at which a corresponding one of pre-defined multiple kinds of living activities (in the present embodiment, at-home state, go-out state, and sleep state) occurs in one day. Each of the prior probabilities of the multiple living activities may be an occurrence probability of a corresponding living activity obtained from a result of an actual inferred living activity in the residence of interest for a predetermined period. Alternatively, each of the prior probabilities of the multiple living activities may be a value that has been statistically obtained preliminarily based on a group of users, the jobs, ages, and/or resident areas of which are similar to those of the resident of interest.

The storage device 17 stores probabilities (first conditional probabilities) each defining active and inactive probabilities of the one or more electric appliances 3 belonging to a corresponding section under a condition where a corresponding one of the three kinds of living activities, namely the sleep state, the at-home state, and the go-out state, occurs. This probability can be obtained from a result of collection of actual operational states of the electric appliances 3 detected by the detector 16 and actual living activities of the resident for a predetermined period, and is stored in the storage device 17. Alternatively, active and inactive probabilities of the one or more electric appliances 3 under a condition where one of the three kinds of living activities, namely the sleep state, the at-home state, and the go-out state, occurs may be obtained preliminarily, and may be stored in the storage device 17.

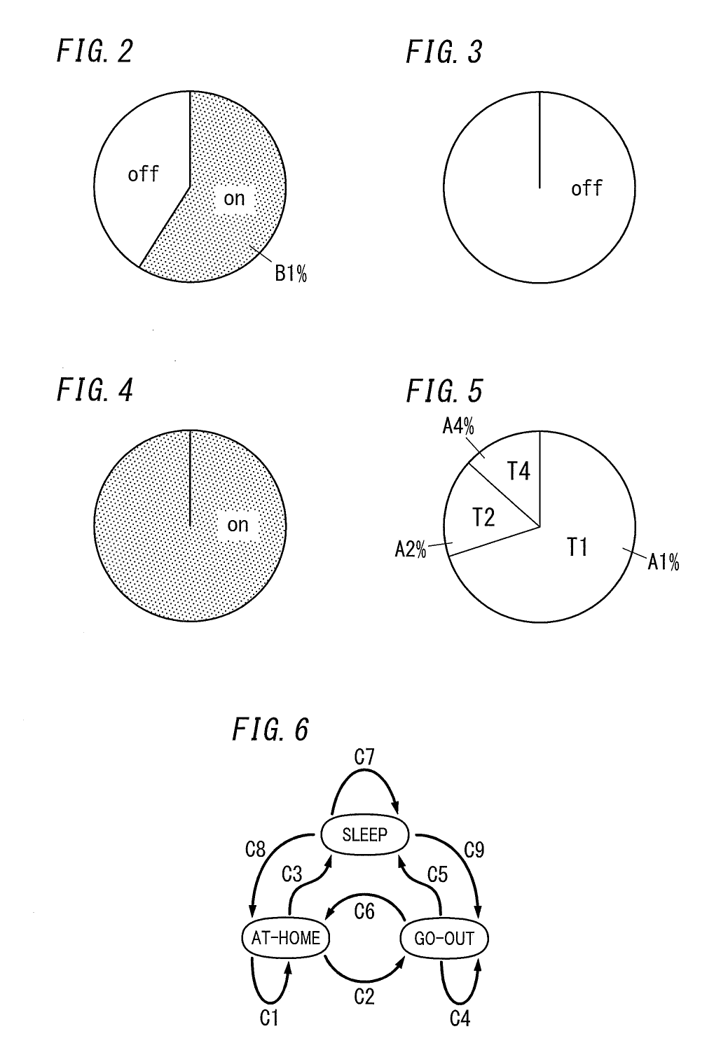

For example, FIG. 2 is a circle graph showing percentages of active (on) and inactive (off) probabilities of the electric appliance 31 belonging to the living room under a condition where the sleep state occurs. In the illustrated example, the active probability is B1 (%). FIG. 3 is a circle graph showing percentages of active and inactive probabilities of the electric appliance 32 belonging to the kitchen under a condition where the sleep state occurs. In the illustrated example, the active probability is 0 (%). In other words, in the example of FIG. 3, the electric appliance 32 is inactive (off). FIG. 4 is a circle graph showing percentages of active and inactive probabilities of the electric appliance 33 belonging to the bed room under a condition where the sleep state occurs. In the illustrated example, the active probability is 100 (%). In other words, in the example of FIG. 4, the electric appliance 33 is active (on).

Further, probabilities (second conditional probabilities) each defining probabilities of occurrence of one of the three kinds of living activities, namely the at-home state, the go-out state, and the sleep state, within respective time periods divided from one day, under a condition where the corresponding living activity occurs, are preliminarily obtained and stored in the storage device 17. In the example, one day is divided into four time periods. Specifically, a time period of 0:00 to 6:00 is defined as a time period T1, a time period of 6:00 to 12:00 is defined as a time period T2, a time period of 12:00 to 18:00 is defined as a time period T3, and a time period of 18:00 to 24:00 is defined as a time period T4. The storage device 17 stores probabilities (second conditional probabilities) each defining probabilities of occurrence of a corresponding one of the three kinds of living activities, namely the at-home state, the go-out state, and the sleep state, within respective time periods T1, T2, T3, T4. For example, FIG. 5 is a circle graph showing probabilities of occurrence of the sleep state within the four time periods T1, T2, T3, and T4, respectively. In the example of FIG. 5, a probability of occurrence of the sleep state within the time period T is A1 (%), a probability of occurrence of the sleep state within the time period T2 is A2 (%), a probability of occurrence of the sleep state within the time period T3 is 0%, and a probability of occurrence of the sleep state within the time period T4 is A4 (%). Since the probability of occurrence of the sleep state within the time period T3 of 12:00 to 18:00 is 0%, the probability with regard to the time period T3 is not shown in FIG. 5.

Also, the storage device 17 preliminarily stores transition probabilities each defining probabilities at which the three kinds of living activities, namely the at-home state, the go-out state, and the sleep state, occur subsequent to a corresponding one of the three kinds of living activities. The transition probabilities are obtained by: inferring living activities every predetermined periods; and counting the number of transitions from a living activity at an inference target time to a living activity at a next inference target time based on the inference result, and are stored in the storage device 17. FIG. 6 shows a state transition diagram of a case where there are three kinds of pre-defined living activities, namely the at-home state, the go-out state, and the sleep state.

In the example of FIG. 6, a transition probability from the at-home state to the at-home state is C1 (%), a transition probability from the at-home state to the go-out state is C2 (%), and a transition probability from the at-home state to the sleep state is C3 (%). Also, a transition probability from the go-out state to the go-out state is C4 (%), a transition probability from the go-out state to the sleep state is C5 (%), and a transition probability from the go-out state to the at-home state is C6 (%). Further, a transition probability from the sleep state to the sleep state is C7 (%), a transition probability from the sleep state to the at-home state is C8 (%), and a transition probability from the sleep state to the go-out state is C9 (%). In general, an event of a transition from the go-out state to the sleep state and an event of a transition from the sleep state to the go-out state are less likely to occur. Therefore, in the example of FIG. 6, the probability C5 of transition from the go-out state to the sleep state and the probability C9 of transition from the sleep state to the go-out state would be zero.

The inputter 18 is a user interface including an operation unit for receiving an input operation and a display unit for displaying the inputted contents. In response to the manipulation on the inputter 18 by the resident, feedback information indicative of a disagreement between an inference result of the living activity inferred by the inferrer 10 and an actual living activity at the inference target time or the like is entered. That is, the inputter 18 is configured to receive the feedback information.

The updater 19 is configured to update at least one of the prior probabilities, the first conditional probabilities, and the second conditional probabilities stored in the storage device 17 based on the feedback information entered through the inputter 18. The updating process of the storage device 17 performed by the updater 19 is described later.

The inferrer 10 receives, as factual information, the operational state of the one or more electric appliances 3 for each of the branch lines L2 detected by the detector 16. The inferrer 10 also receives, as factual information, information that which of time periods T1, T2, T3, and T4 an inference target time is contained in, based on information on time of the inference target time. Therefore, the inferrer 10 uses: a collection of the factual information on the operational state of the one or more electric appliances 3 at the inference target time; and the factual information on which time period the inference target time is contained in, as the input information for Bayesian network. The input information for Bayesian network is information determined as a fact, and therefore is referred to as fixed information. Here, the fixed information is also a collective term for the input information for Bayesian network, and thus may include multiple pieces of factual information.

The inferrer 10 retrieves the prior probabilities, the first conditional probabilities, and the second conditional probabilities from the storage device 17 based on the fixed information. The inferrer 10 calculates joint probabilities of the first conditional probabilities and the second conditional probabilities, thereby obtaining probabilities of occurrence of the living activities at the inference target time, respectively, according to Bayes' theorem.

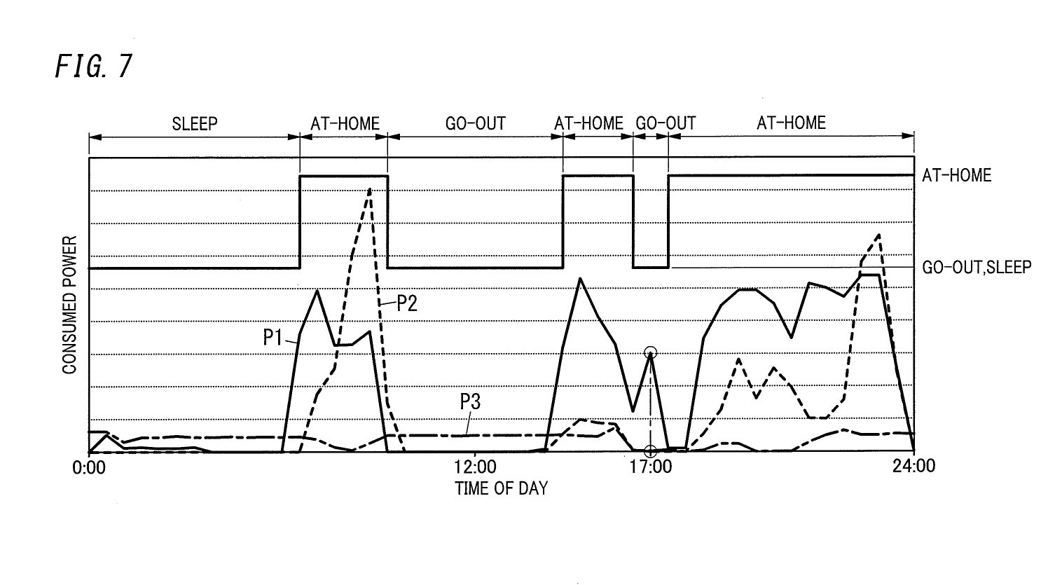

FIG. 7 is a graph illustrating a relationship between: a history of the amount of power P1 consumed by the electric appliance 31; a history of the amount of power P2 consumed by the electric appliance 32; a history of the amount of power P3 consumed by the electric appliance 33; and the living activity of the resident, in one example day. In FIG. 7, the amount of power P1 consumed by the electric appliance 31 belonging to the living room is drawn by a solid line, the amount of power P2 consumed by the electric appliance 32 belonging to the kitchen is drawn by a broken line, and the amount of power P3 consumed by the electric appliance 33 belonging to the bed room is drawn by a dashed-dotted line.

In the example of FIG. 7, when the inferrer 10 attempts to infer the living activity at 17:00, the inferrer 10 retrieves, as a collection of first factual information, the respective operational states at 17:00 of the electric appliances 31, 32, and 33 from the detector 16. In the example of FIG. 7, at 17:00, the electric appliance 31 belonging to the living room is active, the electric appliance 32 belonging to the kitchen is inactive, and the electric appliance 33 belonging to the bed room is inactive. The inferrer 10 also obtains, as second factual information, information on a time period in which the inference target time (i.e., 17:00) is contained.

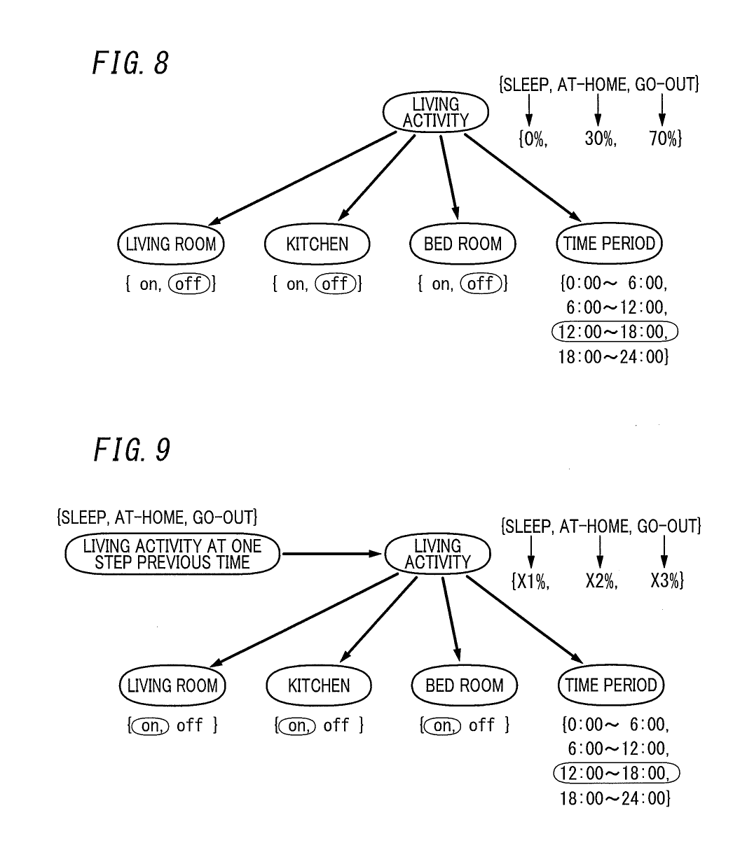

The following explanation referring to Bayesian network shown in FIG. 8 is made to a calculation process by the inferrer 10 for obtaining respective occurrence probabilities at 17:00 of the living activities (at-home state, go-out state, and sleep state). FIG. 8 is a graphical model illustrating a relation among: a living activity of calculation interest; active or inactive probability of each of the electric appliances 31, 32, and 33 under a condition where the living activity of calculation interest occurs (first conditional probabilities); and a probability of occurrence of the living activity of calculation interest within the time period which the inference target time is contained in (second conditional probabilities). For obtaining the occurrence probability of the at-home state, the inferrer 10 retrieves a prior probability defining a probability at which the at-home state occurs in one day, from the storage device 17. Also, the inferrer 10 retrieves from the storage device 17 respective probabilities that the electric appliances 31, 32, and 33 have the operational states detected by the detector 16 under a condition where the at-home state occurs. With regard to the operational states of the example of FIG. 7 at 17:00, the inferrer 10 retrieves, from the storage device 17, a probability at which the electric appliance 31 is active under the condition where the at-home state occurs, a probability at which the electric appliance 32 is inactive under the condition where the at-home state occurs, and a probability at which the electric appliance 33 is inactive under the condition where the at-home state occurs. Also, the inferrer 10 retrieves, from the storage device 17, a probability of occurrence of the at-home state within the time period in which the inference target time is contained (e.g., the time period T3 from 12:00 to 18:00, when the inference target time is 17:00). The inferrer 10 puts the probabilities retrieved from the storage device 17 into corresponding nodes of Bayesian network to calculate the joint probability, thereby obtaining a probability of occurrence of the at-home state at 17:00. The inferrer 10 also obtains a probability of occurrence of the go-out state at 17:00, and a probability of occurrence of the sleep state at 17:00, in a similar manner.

Calculating the probability of occurrence of the at-home state at the inference target time, the probability of occurrence of the go-out state at the inference target time, and the probability of occurrence of the sleep state at the inference target time, the inferrer 10 determines that a living activity having a highest probability has occurred at that time. Alternatively, the inferrer 10 may be configured to determine that a living activity has occurred at that time when a probability of this living activity is highest and is greater than occurrence probabilities of other living activities by a significant value or more. When determining the living activity that has occurred at the inference target time, the inferrer 10 outputs the inference result, or the respective occurrence probabilities of the living activities.

The inferrer 10 may periodically (for example, every several minutes) performs the inferring operation of the living activity described above, and thereby can infer the living activity of the resident over one day, based on the operational states of the electric appliances 3. Also, the inferrer 10 can detect changes in the inferred living activities as events. For example, the inferrer 10 may be configured to detect end of the sleep state as a wake-up event, change from the at-home state to the go-out state as a going-out event defined as start of the go-out state, and change from the go-out state to the at-home state as a coming-home event defined as start of the at-home state.

The inferrer 10 may be configured to use the transition probabilities stored in the storage device 17 for the probabilistic inference of the living activity. The following explanation referring to Bayesian network shown in FIG. 9 is made to a calculation process performed by the inferrer 10 for obtaining occurrence probabilities of the living activities at a certain time point using transition probabilities of transition from a living activity at one step previous time.

FIG. 9 is a graph illustrating a relation among: a living activity of calculation interest; a living activity at one step previous time; active or inactive probability of each of the electric appliances 31, 32, and 33 under a condition where the living activity of calculation interest occurs; and a probability of occurrence of the living activity of calculation interest within the time period in which the inference target time is contained.

When attempting to infer a living activity at a certain time point, the inferrer 10 retrieves, as a collection of the first factual information, the respective operational states at the inference target time of the electric appliances 31, 32, and 33 from the detector 16. The inferrer 10 also obtains, as the second factual information, the information on a time period in which the inference target time is contained. The inferrer 10 then calculates the respective probabilities of occurrence of the at-home state, the go-out state, and the sleep state, based on the fixed information including the first factual information and the second factual information.

For example, for obtaining the occurrence probability of the at-home state, the inferrer 10 retrieves a prior probability defining a probability at which the at-home state occurs in one day, from the storage device 17. Also, the inferrer 10 retrieves respective transition probabilities defining probabilities of transitions to the at-home state from the at-home state, from the go-out state, and from the sleep state, at one step previous time (previous inference target time), respectively, from the storage device 17. Further, the inferrer 10 retrieves from the storage device 17 the respective probabilities that the electric appliances 31, 32, and 33 have the operational states detected by the detector 16 under a condition where the at-home state occurs.

The inferrer 10 puts the probabilities retrieved from the storage device 17 into corresponding nodes of Bayesian network to calculate the joint probability, thereby obtaining a probability of occurrence of the at-home state at the inference target time. The inferrer 10 also obtains a probability of occurrence of the go-out state at the inference target time, and a probability of occurrence of the sleep state at the inference target time, in a similar manner.

When the living activity is inferred using the transition probabilities, it is possible to reduce a probability of determining that a living activity that is less likely to occur in daily life has occurred, leading to improvement of inference accuracy of the living activity. For example, in daily life, a transition probability that the go-out state occurs subsequent to the sleep state, and a transition probability that the sleep state occurs subsequent to the go-out state are low. Therefore, it is possible to reduce the possibilities that such living activities are determined to occur.

Preferably, the living activity inference device 1 of the present embodiment allows a user to input the feedback information indicative of a disagreement between an inference result of living activity and an actual living activity (true value) to update the information on the probabilities stored in the storage device 17.

The following explanation is given to a supposed case where the inferrer 10 of the living activity inference device 1 is configured to transmit an inference result of the living activity to a mobile terminal held by a parent who is out of home so as to allow the parent to grasp the living activity of a child.

The inferrer 10 of the living activity inference device 1 periodically infers the living activity. When detecting that a child comes back the home in which no resident is present, the inferrer 10 determines that a coming-home event occurs, and gives push notification by transmitting, for example, by e-mail, the inference result to the mobile terminal held by the parent. Specifically, the living activity inference device 1 includes the communicator connectable to the telecommunication network such as the Internet and the mobile network. When determining that the coming-home event has occurred, the inferrer 10 transmits, through the communicator, an e-mail indicative of occurrence of the coming-home event to a preliminarily registered mail address of the mobile terminal.

When receiving the push notification from the living activity inference device 1, the parent can give a call on a telephone in the residence or a mobile phone held by the child to ask whether the child has come home and/or the coming home time, and thereby can determine whether the inference result of the living activity inference device 1 is correct or not.

When the inference result of the living activity inference device 1 is correct, the parent is expected not to enter the feedback information on the living activity inference device 1. When no feedback information is entered on the living activity inference device 1, the updater 19 does not update the data on the probabilities stored in the storage device 17. Since the inference result is correct, there is no problem.

On the other hand, when the inference result of the living activity inference device 1 is not correct, the parent is expected to enter the feedback information on the living activity inference device 1 to update the data on the probabilities stored in the storage device 17.

In this regard, the following explanation is given to a case where the living activity inference device 1 determines occurrence of a coming-home event and transmits an e-mail indicative of occurrence of the coming-home event to the mobile terminal held by the parent and the parent out of the home thus asks the child whether the child has come home but finds that the child has not come home yet in fact.

In this case, the parent (resident) would confirm a fact that the child has not come home yet when the living activity inference device 1 inferred the occurrence of the coming-home event and a time when the child actually came home. After coming home, the parent can operate the inputter 18 to enter the actual coming-home time.

Then, the updater 19 performs the updating process of the storage device 17 based on the feedback information entered through the inputter 18. For example, it is supposed that the inferrer 10 determines that the coming-home event has occurred at 16:00, but nevertheless the actual coming-home event has occurred at 17:00. In this case, the parent can use the inputter 18 to enter the information indicating that the inference that the coming-home event has occurred at 16:00 is incorrect and the actual coming-home event has occurred at 17:00.

In this case, a time period of the go-out state is prolonged. Therefore, the updater 19 updates the first conditional probabilities so that, with regard to an electric appliance 3 determined to be active under the condition where the go-out state occurs, the active probability under the condition where the go-out state occurs is increased by a certain value. Also, the updater 19 updates the first conditional probabilities so that, with regard to an electric appliance 3 determined to be inactive under the condition where the go-out state occurs, the inactive probability under the condition where the go-out state occurs is increased by a certain value.

Also, a time period of the at-home state is shortened. Therefore, the updater 19 updates the first conditional probabilities so that, with regard to an electric appliance 3 determined to be active under the condition where the at-home state occurs, the active probability under the condition where the at-home state occurs is decreased by a certain value. Also, the updater 19 updates the first conditional probabilities so that, with regard to an electric appliance 3 determined to be inactive under the condition where the at-home state occurs, the inactive probability under the condition where the at-home state occurs is decreased by a certain value.

Also, the updater 19 updates to increase the prior probability at which the go-out state occurs in one day by a certain value, and changes the second conditional probabilities at which the go-out state occurs within the respective time periods T1, T2, T3, and T4. Also, the updater 19 updates to decrease the prior probability at which the at-home state occurs in one day by a certain value, and changes the second conditional probabilities at which the at-home state occurs within the respective time periods T1, T2, T3, and T4.

Explained next is a case where the living activity inference device 1 fails to infer that the coming-home event has occurred, though the child actually has come home.

The parent confirms that the child has already come home by calling on the telephone in the residence or the mobile phone held by the child, without notified by the living activity inference device 1 of occurrence of the coming-home event. In this case, the parent can hear the actual coming-home time from the child. Then, after coming home, the parent can operate the inputter 18 to enter the actual coming-home time.

Then, the updater 19 performs the updating process of the storage device 17 based on the feedback information entered through the inputter 18. For example, it is supposed that the child actually has come home at 15:00, but nevertheless the inferrer 10 has inferred that the go-out state continues after this time. In this case, the parent can use the inputter 18 to enter the information indicating that the inference that the go-out state after 15:00 is incorrect and the coming-home event has occurred at 15:00.

In this case, a time period of the go-out state is shortened. Therefore, the updater 19 updates the first conditional probabilities so that, with regard to an electric appliance 3 determined to be active under the condition where the go-out state occurs, the active probability under the condition where the go-out state occurs is decreased by a certain value. Also, the updater 19 updates the first conditional probabilities so that, with regard to an electric appliance 3 determined to be inactive under the condition where the go-out state occurs, the inactive probability under the condition where the go-out state occurs is decreased by a certain value.

Also, a time period of the at-home state is prolonged. Therefore, the updater 19 updates the first conditional probabilities so that, with regard to an electric appliance 3 determined to be active under the condition where the at-home state occurs, the active probability under the condition where the at-home state occurs is increased by a certain value. Also, the updater 19 updates the first conditional probabilities so that, with regard to an electric appliance 3 determined to be inactive under the condition where the at-home state occurs, the inactive probability under the condition where the at-home state occurs is increased by a certain value.

Also, the updater 19 updates to increase the prior probability at which the at-home state occurs in one day by a certain value, and changes the second conditional probabilities at which the at-home state occurs within the respective time periods T1, T2, T3, and T4. Also, the updater 19 updates to decrease the prior probability at which the go-out state occurs in one day by a certain value, and changes the second conditional probabilities at which the go-out state occurs within the respective time periods T1, T2, T3, and T4.

As described above, the updater 19 updates the data on probabilities which is stored in the storage device 17 and related to the feedback information, based on the feedback information entered through the inputter 18. Accordingly, the inference accuracy of the living activity can be improved.

In the present embodiment, the inferrer 10 is configured to perform a process of detecting change in the inference result with regard to the living activities as an event, and record a pattern of occurrence of the event in one day. The inferrer 10 may be configured to determine that there is irregularity in occurrence of the living activities when an occurrence timing of the event detected after the pattern is recorded does not conform to the pattern.

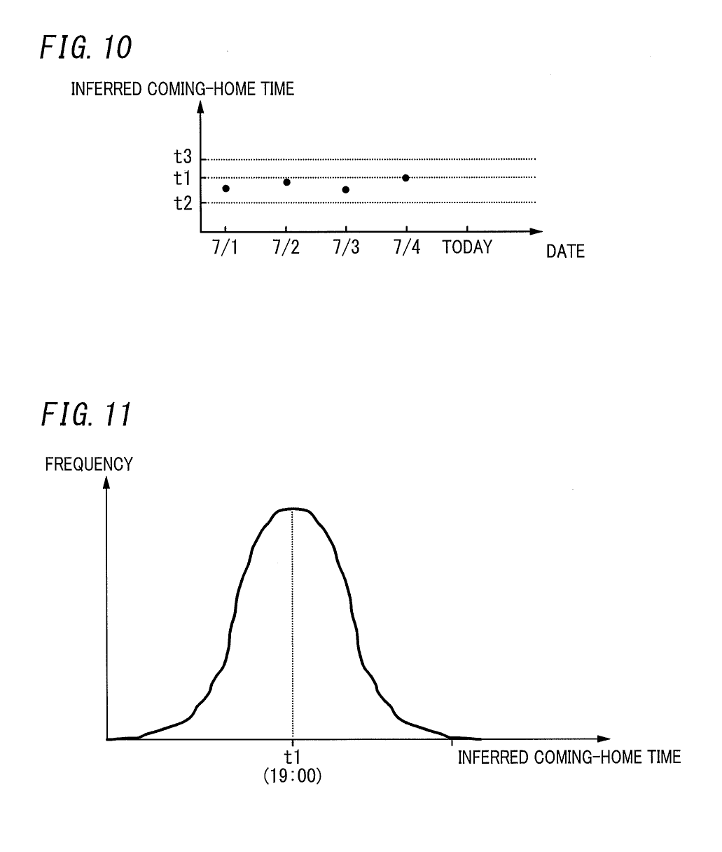

For example, it will be explained a case where a result of recording the coming-home event of the resident by the inferrer 10 every weekday shows an occurrence time of the coming-home event (inferred coming-home time) changes as shown in FIG. 10. FIG. 11 is a graph showing a frequency distribution of the inferred coming-home time, and the frequency distribution of the inferred coming-home time shows a normal probability distribution of which average time is t1. The inferrer 10 refers to the history of the inferred coming-home time, and determines that there is irregularity in occurrence of the living activities when a time at which a coming-home event has determined to have occurred is out of a given range including the average time t1 (for example, the given range indicates a period from a time t2 to a time t3, and this period corresponds to the “pattern” mentioned in the present disclosure). When determining that there is irregularity in occurrence of the living activities, the inferrer 10 gives push notification by transmitting an e-mail informing that there is irregularity in occurrence of the living activities, to the mobile terminal owned by the parent through the communicator, for example. In this case, the coming-home event of the resident is recorded every weekday. Alternatively, the coming-home event may be recoded every day of the week on which the resident has almost the same life rhythm.

Explained above is a case for detecting presence of irregularity with regard to the coming-home event. Alternatively, presence of irregularity with regard to the wake-up event may be detected so that irregularity in the wake-up event can be informed. For example, the inferrer 10 may record a pattern of the wake-up event of the resident everyday, and may determine that there is irregularity in occurrence of the living activities when a wake-up event occurs at a time not conforming to the pattern. This example may be applied to a system for detecting a trouble in a person who lives alone.

As described above, the living activity inference device 1 of the present embodiment includes the obtainer 12, the detector 16 (appliance operation detector), the storage device 17, and the inferrer 10 (activity inferrer). The obtainer 12 is configured to obtain, for each of sections of a residence, data on a resource consumption status of one or more appliances (one or more electric appliances 3 in the present embodiment) belonging to a corresponding one of the sections. The detector 16 is configured to determine, for each of the sections, an operational state indicative of whether the one or more appliances belonging to a corresponding one of the sections are active or inactive, from the data on the resource consumption status obtained by the obtainer for each of the sections. The storage device 17 is configured to preliminarily store the prior probabilities, the first conditional probabilities, and the second conditional probabilities. The prior probabilities each define a probability at which a corresponding one of pre-defined multiple kinds of living activities occurs in one day. The first conditional probabilities each define active and inactive probabilities of the one or more appliances belonging to a corresponding one of the sections under a condition where a corresponding one of the multiple kinds of living activities occurs. The second conditional probabilities each define probabilities of occurrence of a corresponding one of the multiple kinds of living activities within respective time periods divided from one day under a condition where the corresponding one of the multiple kinds of living activities occurs. The inferrer 10 is configured to calculate, for each of the multiple kinds of living activities, an occurrence probability defining a probability that a corresponding one of the multiple kinds of living activities occurs at an inference target time, according to Bayes' theorem based on the operational state of the one or more appliances determined by the detector 16 for each of the sections at the inference target time by use of the prior probabilities, the first conditional probabilities, and the second conditional probabilities. The inferrer 10 is also configured to infer that a living activity having a highest occurrence probability of the multiple kinds of living activities has occurred at the inference target time.

The inferrer 10 calculates, for each of the multiple kinds of living activities, an occurrence probability according to the Bayes' theorem by use of the prior probabilities, the first conditional probabilities, and the second conditional probabilities stored in the storage device 17 with the operational states at the inference target time of the appliances as the input information. Therefore, it is possible to determine which of probabilities of occurrence of the living activities is the highest, from the occurrence probabilities defining probabilities of occurrence of the multiple kinds of living activities. Accordingly, it is possible to infer the living activity at the inference target time with an improved accuracy compared to the conventional example.

In the living activity inference device 1, the one or more appliances are one or more electric appliances 3, and the distribution board 2 in the residence is connected to the branch lines L2. Each of the branch lines L2 is connected to at least one electric appliance 3 of the one or more electric appliances 3 belonging to a corresponding one of the sections, and delivers electricity from the distribution board 2 to the at least one of the one or more electric appliances 3 connected thereto. The obtainer 12 is preferably configured to obtain, for each of the branch lines L2, power data. In general, one or more electric appliances 3 belonging to the same section in the residence are connected to the same branch line L2. Therefore, the detector 16 can determine, for each of the sections, whether the one or more electric appliances 3 in this section are active or inactive, from the consumption status of the amount of energy obtained by the obtainer 12 for each of the branch lines L2.

In the living activity inference device 1, the storage device 17 may be configured to preliminarily store transition probabilities each defining probabilities at which the multiple kinds of living activities occur subsequent to a corresponding one of the multiple kinds of living activities. The inferrer 10 is preferably configured to further use the transition probabilities for calculating, for each of the multiple kinds of living activities, the occurrence probability at the inference target time. Some of the living activities are less likely to occur subsequent to a certain living activity. Therefore, the inference accuracy of the living activity can be improved by using the transition probabilities for inferring the living activity.

The living activity inference device 1 may further include the inputter 18 and the updater 19. The inputter 18 is configured to receive feedback information indicative of a disagreement between an inference result of the inferrer 10 and an actual living activity of a user at the inference target time. The updater 19 is configured to update at least one of the prior probabilities, the first conditional probabilities, and the second conditional probabilities stored in the storage device 17, based on the feedback information received through the inputter 18. The updater 19 updates the information on the probabilities stored in the storage device 17 based on the feedback information, and this can lead to improvement of the inference accuracy of the living activity.

In the living activity inference device 1, preferably, the multiple kinds of living activities include the at-home state, the go-out state, and the sleep state. With this configuration, the living activity of the resident can be inferred based on the classification of the at-home state, the go-out state, and the sleep state. However, the living activities to be inferred by the inferrer 10 are not limited to the at-home state, the go-out state, and the sleep-state. For example, the inferrer 10 may be configured to infer more detailed living activities in the residence, such as a at-table state, and a bathing state.

In the living activity inference device 1, the inferrer 10 is configured to periodically perform a process of detecting change in an inference result with regard to the multiple kinds of living activities as an event, and record a pattern (pattern repeated everyday) of occurrence of the event in one day. The inferrer 10 may be configured to determine that there is irregularity in occurrence of the multiple kinds of living activities when an occurrence timing of an event detected after the pattern is recorded does not conform to the pattern. The inferrer 10 can infer the living activity from the result of the resource consumption status of the one or more appliances for each section, and can determine the irregularity in occurrence of the living activities.

The program according to the present embodiment is a program that causes, when executed on a computer, the computer to function as the living activity inference device 1. The program may be recorded on a computer readable recording medium. The computer may execute the program recorded on the recoding medium, or the computer may install the program recorded on the recording medium and execute the installed program. The program may be provided through the telecommunication network such as the Internet.

The present embodiment is described with an example where the appliances consuming the resource are electric appliances. However, the appliances may be gas appliances consuming gas, or water consuming appliances (such as a faucet, a toilet, and a bathtub) consuming water. In the case of the gas appliances, operational states of the gas appliances can be determined from the gas consumption statuses. The gas consumption status can be obtained from a flow rate of the gas measured by a flow meter provided in a flow channel of the gas, or information measured by sensors provided to the gas appliances. In the case of water consuming appliances, operational states of the water consuming appliances can be determined from the water consumption statuses. The water consumption status can be obtained from a flow rate of water measured by a flow meter provided in a flow channel of the water, or information measured by sensors provided to the water consuming appliances.

The present embodiment described above is a mere example of the present invention, and the scope of the present invention is not limited to the embodiment described above but includes other embodiments and numerous modifications and variations of the aforementioned embodiment without departing from the technical concept of the present invention.

1. A living activity inference device, comprising:
an obtainer configured to obtain, for each of sections of a residence, data on a resource consumption status of one or more appliances belonging to a corresponding one of the sections;
an appliance operation detector configured to determine, for each of the sections, an operational state indicative of whether the one or more appliances belonging to a corresponding one of the sections are active or inactive, from the data on the resource consumption status obtained by the obtainer for each of the sections;
a storage device configured to preliminarily store
prior probabilities each defining a probability at which a corresponding one of pre-defined multiple kinds of living activities occurs in one day,
first conditional probabilities each defining active and inactive probabilities of the one or more appliances belonging to a corresponding one of the sections under a condition where a corresponding one of the multiple kinds of living activities occurs, and
second conditional probabilities each defining probabilities of occurrence of a corresponding one of the multiple kinds of living activities within respective time periods divided from one day under a condition where the corresponding one of the multiple kinds of living activities occurs; and
an activity inferrer configured to
calculate, for each of the multiple kinds of living activities, an occurrence probability defining a probability that a corresponding one of the multiple kinds of living activities occurs at an inference target time, according to Bayes' theorem based on the operational state of the one or more appliances determined by the appliance operation detector for each of the sections at the inference target time by use of the prior probabilities, the first conditional probabilities, and the second conditional probabilities, and
infer that a living activity having a highest occurrence probability of the multiple kinds of living activities has occurred at the inference target time.

2. The living activity inference device of claim 1, wherein
the one or more appliances are one or more electric appliances,
a distribution board in the residence is connected to branch lines,
each of the branch lines is connected to at least one of the one or more electric appliances belonging to a corresponding one of the sections, and delivers electricity from the distribution board to the at least one of the one or more electric appliances connected thereto, and
the obtainer is configured to obtain, for each of the branch lines, power data.

3. The living activity inference device of claim 1, wherein
the storage device is configured to preliminarily store transition probabilities each defining probabilities at which the multiple kinds of living activities occur subsequent to a corresponding one of the multiple kinds of living activities, and
the activity inferrer is configured to further use the transition probabilities for calculating, for each of the multiple kinds of living activities, the occurrence probability at the inference target time.

4. The living activity inference device of claim 1, further comprising:
an inputter configured to receive feedback information indicative of a disagreement between an inference result of the activity inferrer and an actual living activity of a user at the inference target time, and
an updater configured to update at least one of the prior probabilities, the first conditional probabilities, and the second conditional probabilities stored in the storage device, based on the feedback information received through the inputter.

5. The living activity inference device of claim 1, wherein the multiple kinds of living activities include an at-home state, a go-out state, and a sleep state.

6. The living activity inference device of claim 1, wherein
the activity inferrer is configured to
periodically perform a process of detecting change in an inference result with regard to the multiple kinds of living activities as an event,
record a pattern of occurrence of the event in one day, and
determine that there is irregularity in occurrence of the multiple kinds of living activities when an occurrence timing of the event detected after the pattern is recorded does not conform to the pattern.

7. A program that when executed on a computer, causes the computer to function as the living activity inference device of claim 1.
